(19) United States
(12) Patent Application Publication
(10) Pub. No.: US 2024/0367142 A1
(43) Pub. Date: Nov. 7, 2024

(54) POLYMER-TEMPLATED HYDROXYAPATITE AND USES THEREOF FOR PURIFICATION OF TARGET MOLECULES

(71) Applicant: BIO-RAD LABORATORIES, INC., HERCULES, CA (US)

(72) Inventors: BRIAN PANGANIBAN, HERCULES, CA (US); SHAWN DARNALL, HERCULES, CA (US); DANNI WANG, HERCULES, CA (US); CHRISTOPHER BELISLE, WALNUT CREEK, CA (US)

(21) Appl. No.: 18/652,908

(22) Filed: May 2, 2024

Related U.S. Application Data
(60) Provisional application No. 63/463,322, filed on May 2, 2023.

(51) Int. Cl. B01J 20/04; B01J 20/282; C01B 25/32

(52) U.S. Cl. CPC B01J 20/048; B01J 20/282; C01B 25/322; B01J 2220/54

(57) ABSTRACT

Provided herein is a chromatography media composed of a particulate substrate (such as beads or other particulate substrates) that is coated with hydroxyapatite (HA) and in which the particulate substrate used as the base upon which calcium phosphate (CaP) is formed is treated with heat to remove the substrate, convert the CaP to HA, and form the desired HA microstructure so as to form a templated porous HA substrate (TPHA substrate). Also provided is a chromatography media (optionally contained within a column) comprising a TPHA substrate (e.g., a plurality of TPHA particles). The TPHA particles are porous or macroporous and uses thereof.

### CROSS-REFERENCE TO RELATED APPLICATION

This application claims the benefit of U.S. Provisional Application Ser. No. 63/463,322, filed May 2, 2023, the disclosure of which is hereby incorporated by reference in its entirety, including all figures, tables and amino acid or nucleic acid sequences.

Hydroxyapatite purification media has several drawbacks. Ceramic hydroxyapatite (CHT), for example, is complicated and expensive to produce and is difficult to control its pore network. This disclosure provides a new hydroxyapatite chromatography media that is produced using polymer as a negative template for macroporous hydroxyapatite particulates.

### BRIEF SUMMARY OF THE INVENTION

Provided herein is a chromatography media composed of a particulate substrate (such as beads or other particulate substrates) that is coated with hydroxyapatite (HA) and in which the particulate substrate used as the base upon which calcium phosphate (CaP) is formed is treated with heat to remove the substrate, convert the CaP to HA, and form the desired HA microstructure so as to form a templated porous HA substrate (TPHA substrate). Also provided is a chromatography media (optionally contained within a column) comprising a TPHA substrate (e.g., a plurality of TPHA particles). The TPHA particles are porous or macroporous.

Also provided is a method of preparing the TPHA substrate. In some embodiments, the method comprises incubating a particulate substrate comprising epoxide groups, with phosphoric acid to form a substrate bearing phosphate groups. The phosphoric acid-derivatized substrate can then be mineralized with calcium phosphate to form a substrate coated with calcium phosphate (e.g., a brushite form of calcium phosphate). Calcium phosphate-coated substrates are then treated with heat to form a TPHA particle in which the substrate is substantially removed, the CaP is converted to HA, and the microstructure of the HA is optimized for binding and mechanical properties. The particulate substrate underlying the HA of the TPHA particle is substantially removed when the HA-coated substrate is pyrolyzed to substantially remove the particulate substrate underlying the HA to form the TPHA. The TPHA substrates disclosed herein are macroporous and have increased binding capacity as compared to standard CHT.

Also provided are methods of performing chromatography. In some embodiments, the method comprises contacting a sample comprising a target molecule with a TPHA substrate as disclosed herein under conditions such that the target is not captured by the TPHA substrate; and collecting the target molecule in flow-through from the particulate TPHA substrate.

In other embodiments, the method comprises contacting a sample comprising a target molecule with a TPHA substrate as disclosed herein under conditions such that the target is captured by the TPHA substrate; and collecting the target molecule in an eluate from the particulate TPHA substrate.

In some embodiments, the sample comprises a contaminant that is captured by the particulate TPHA substrate. In some embodiments, the collecting step comprises collecting one or more fractions enriched for the target molecule from the particulate TPHA substrate. In other embodiments, the collecting step comprises applying centrifugal force or a vacuum to the particulate TPHA substrate and collecting one or more fractions enriched for the target molecule from the particulate TPHA substrate. In some embodiments, the protein is an antibody or another therapeutic protein. In some embodiments, the protein is an IgG antibody.

### BRIEF DESCRIPTION OF THE DRAWINGS

FIG. 1 illustrates an exemplary method by which a TPHA particle can be formed. Particles can be sintered (pyrolyzed) at a desired temperature, such as temperatures above about 400° C.

### DETAILED DESCRIPTION OF THE INVENTION

This disclosure relates to particulate TPHA substrates, methods of making particulate TPHA substrates, and methods of using particulate TPHA substrates.

### Definitions

The term “hydroxyapatite” refers to an insoluble hydroxylated mineral of calcium phosphate with the structural formula Ca₁₀(PO₄)₆O(OH)₂. Hydroxyapatite chromatography is considered a multimodal process in that it has multiple modes of interaction with biomolecules. Its dominant modes of interaction are phosphoryl cation exchange and calcium metal affinity. Hydroxyapatite is commercially available in a variety of forms including, but not limited to, ceramic hydroxyapatite which is a chemically pure form of hydroxyapatite that has been sintered at high temperature to modify it from a crystalline to a ceramic form. Ceramic hydroxyapatite is spherical in shape, with particle diameters ranging from about 10 microns to about 100 microns, and is typically available at nominal diameters of 20 microns, 40 microns, and 80 microns. Ceramic hydroxyapatite (or CHT) is macroporous, and is available in two types: Type I, with a medium porosity and a relatively high binding capacity, and Type II, with a larger porosity and a lower binding capacity. All of the apatite-based HA-coated substrates in this paragraph are available from Bio-Rad Laboratories, Inc. (Hercules, Calif., USA).

The term “antibody” refers to an immunoglobulin or fragmentary form thereof. The term includes, but is not limited to, polyclonal or monoclonal antibodies of the classes IgA, IgD, IgE, IgG, and IgM, derived from human or other mammalian cell lines, including natural or genetically modified forms such as humanized, human, single-chain, chimeric, synthetic, recombinant, hybrid, mutated, grafted, and in vitro generated antibodies. “Antibody” encompasses composite forms including, but not limited to, fusion proteins containing an immunoglobulin moiety. “Antibody” also includes antibody fragments such as Fab, F(ab′)2, Fv, scFv, Fd, dAb, Fc and other compositions, whether or not they retain antigen-binding function.

The term “protein” is used to denote an amino acid polymer or a set of two or more interacting or bound amino acid polymers. The term applies to amino acid polymers in which one or more amino acid residue is an artificial chemical mimetic of a corresponding naturally occurring amino acid, as well as to naturally occurring amino acid polymers, those containing modified residues, and non-naturally occurring amino acid polymers. The term “protein” includes therapeutic proteins, including, but are not limited to, Factor VIII von Willebrand Factor enzymes, growth regulators, clotting factors, cytokines, hormones, transcription factors and phosphoproteins.

The term “TPHA substrate” as referred to within this disclosure is meant to denote a particulate substrate that is coated with HA and in which the particulate substrate is pyrolyzed such that the particulate substrate is substantially removed from the TPHA particle. Particulate substrates include spherical or oblong particles having diameters of between about 1 μm and about 1000 μm. For example, particles (also referred to as particulate substrates can be identified as small-sized particles (<about 50 μm), medium-sized particles (about 50 to about 100 μm), or large-sized particles (greater than about 100 μm). Particles can, of course, have other shapes, such as a shard-like shape. Where spherical particles are used as a substrate, the spherical particles can be monodisperse or polydisperse in size distribution. In other embodiments, the particulate substrate comprise structures selected from cubes, cuboids, prisms, pyramids, platonic solids, torus, cone, cylinder, spheres and mixtures thereof. In any of these embodiments, the particles have at least one dimension (length, width, diameter, and/or height) that is between about 1 μm and about 1000 μm; between about 5 μm and about 750 μm; between about 5 μm and about 600 μm; between about 5 μm and about 500 μm; between about 5 μm and about 400 μm; between about 5 μm and about 250 μm; between about 5 μm and about 150 μm; or between about 5 μm and about 100 μm. The term “TPHA substrate” can be used interchangeably with the term “TPHA particle”.

The term “substantially removed” refers to the elimination of the particulate substrate at the core of a TPHA particle prior to its pyrolyzation and denotes that the particulate substrate is degraded by at least: about 50%, about 55%, about 60%, about 65%, about 70%, about 75%, about 80%, about 85%, about 90%, about 91%, about 92%, about 93, about 94%, about 95%, about 96%, about 97%, about 98%, about 99%, or 100% as compared to the non-pyrolyzed substrate. In certain embodiments, the pyrolyzation process completely eliminates the particulate substrate used to form the TPHA particle.

The term “sample” refers to any composition containing a target molecule that is desired to be purified. The term “contaminant” refers to any impurity that is to be removed from a sample. In some embodiments, the sample is a composition comprising antibodies and other contaminating proteins from a cell culture.

As used herein, the terms “a”, “an” and “the” are intended to mean “one or more.” As used herein, the term “about” refers to the recited number and any value within 10% of the recited number and includes each discrete value such as ±1%, ±2%, ±3%, ±4%, ±5%, ±6%, ±7%, ±8%, ±9% or ±10%, Thus, “about 5” refers to any value between 4.5 and 5.5, including 4.5 and 5.5.

The term “and/or” as used herein refers to and encompasses any and all possible combinations of one or more of the associated listed items. For example, the phrase “A, B, and/or C” includes A alone, B alone, C alone, the combination of A and B, the combination of A and C, the combination of B and C, and the combination of A, B, and C. Also, the term “or” is used in its inclusive sense (and not in its exclusive sense) so that when used, for example, to connect a list of items, the term “or” means one, some, or all of the items in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z).

The term “substrate” refers to a solid particulate substrate, such as beads, particles, or other particulate substrates. Such substrates are coated with calcium and phosphate to form HA. The substrate may be porous (micro-porous or macro-porous) or non-porous. The substrate can be derivatized with an epoxide or another group that can be derivatized to contain a hydroxyl group, amine group (e.g., a quarternary amine group), aldehyde group, azide group, alkyne group, alkene group, phosphate group, sulfonate group, sulfate group, and/or carboxylic acid group. Substrates can also comprise a hydroxyl group, amine group (e.g., a quarternary amine group), aldehyde group, azide group, alkyne group, alkene group, phosphate group, sulfonate group, sulfate group, and/or carboxylic acid group attached to a linker coupled to the substrate. Particulate substrates can be formed from methacrylate, polystyrene, agarose, dextran, cellulose, polyacrylamide, or any other suitable substrate that can be derivatized to have a hydroxyl group, amine group (e.g., a quarternary amine group), aldehyde group, azide group, alkyne group, alkene group, phosphate group, sulfonate group, sulfate group, and/or carboxylic acid exposed on the surface of the substrate. The substrate particles can have any shape, such a spherical or shard-like and can also be rigid or malleable. In certain embodiments, rigid substrates are preferred. The substrate can be polydisperse or monodisperse with respect to its size distribution. Porous substrates can contain pores of any desired size. For example, the pores can have a median diameter of about 0.5 micron or greater or the pores can have a median diameter less than about 0.5 micron or about 0.1 micron. After pyrolysis, the HA-coated substrates may be referred to as TPHA substrates or TPHA particles.

### Methods

Protein purification utilizing a particulate TPHA substrate in accordance can be achieved by conventional means known to those of skill in the art. Examples of proteins include but are not limited to antibodies, enzymes, growth regulators, clotting factors, transcription factors, and phosphoproteins. In many such conventional procedures, the particulate TPHA substrate prior to use is equilibrated with a buffer (“an equilibration buffer”) at the pH that will be used for the binding of the target molecule (e.g., antibody or non-antibody protein). Equilibration can be done with respect to all features that will affect the binding environment, including ionic strength and conductivity when appropriate.

In some embodiments, the particulate TPHA substrates described herein can be used in “bind-elute” mode to purify a target molecule from a biological sample. In some embodiments, following binding of the target molecule to the particulate TPHA substrate, a change in phosphate concentration pH can be used to elute the target molecule.

In some embodiments, once the particulate TPHA substrate is equilibrated, the sample containing a target molecule is loaded onto the particulate TPHA substrate (a “loading step”), the sample optionally being diluted or equilibrated into the equilibration buffer) and the target molecule is allowed to bind to the particulate TPHA substrate. Once bound to the particulate TPHA substrate, the particulate TPHA substrate can be washed with a “wash buffer” to remove contaminants not bound to the particulate TPHA substrate.

Non-limiting examples of buffers suitable for use in connection with chromatography using the disclosed particulate HA-coated substrate include phosphate buffers (e.g., monosodium, disodium, and/or trisodium phosphate buffers), ammonium phosphate, alkalicalcium phosphate, and potassium phosphate (monobasic and/or dibasic) buffers. The buffers are, generally, prepared at concentrations of about 5 mM to about 100 mM, about 5 mM to about 75 mM, about 5 mM to about 50 mM or about 20-50 mM. These buffers, may, optionally, further comprise a salt. Examples of salts that can be used for this purpose are alkali metal and alkaline earth metal halides, notably sodium and potassium halides, and as a specific example NaCl or KCl. Other salts include sulfates, acetates, bromides, perchlorates, iodides, thiocyanates and suitable cations, such as ammonium, alkali metals and alkaline earth metals.

Non-limiting examples of buffers suitable for use in connection with the disclosed chromatography substrate include acetate buffers (e.g., sodium acetate), acetic acid, malonic acid, succinate buffers, imidazole buffers, arginine buffers, glycine buffers, HEPES (2-[4-(2-hydroxyethyl)piperazin-1-yl]ethanesulfonic acid), BICINE (N,N-Bis(2-hydroxyethyl)glycine), TRIS (Tris(hydroxymethyl)aminomethane), MES (2-Morpholinoethanesulfonic acid monohydrate or ACES (N-(2-Acetamido)-2-aminoethanesulfonic acid) buffers. The buffers are, generally, prepared at concentrations of about 10 mM to about 100 mM, or about 20-50 mM. Each of these buffers can contain calcium and/or phosphate ions, for example at a concentration of about 1 mM to about 50 mM, 1 mM to about 40 mM, 1 mM to about 30 mM, 1 mM to about 20 mM, 1 mM to about 10 mM, or 1 mM to about 5 mM.

Alternatively, conditions and reagents that are used as in standard HA-based chromatography can be used with the disclosed particulate TPHA substrates. For example, any buffer can be used, such as those containing cations such as sodium, potassium, ammonium, magnesium, and calcium, and anions such as chloride, fluoride, acetate, phosphate, and citrate. The pH of the equilibration solution is typically about 6.0 or higher, in many cases the pH is within the range of about 6.5 to about 8.6 or a range of about 6.5 to about 7.8. In some embodiments, equilibration of a particulate TPHA substrate as disclosed herein may take place in a solution comprising a Tris or a sodium phosphate buffer. The sodium phosphate buffer may be, for example, present at a concentration from about 0.5 mM to about 50 mM, or from about 10 mM to about 35 mM.

In some embodiments, the particulate TPHA substrate may be washed with a wash buffer, such as the equilibration buffer, to remove any unbound proteins or substances that may have been present in the source liquid. The bound protein (e.g., antibody or non-antibody protein, as desired) can be subsequently eluted with an elution buffer. Isocratic elution, stepwise elution in which buffer conditions or salt conditions are changed, or gradient elution using, for example, a buffer at a constant pH and a salt gradient or a gradient of phosphate ions can be used for eluting a protein of interest.

In other embodiments, the binding and washing steps are performed with the inclusion of at least one salt in the sample and wash liquids. Examples of salts that can be used for this purpose are alkali metal and alkaline earth metal halides, notably sodium and potassium halides, and as a specific example sodium chloride. The concentration of the salt can vary; in most cases, an appropriate concentration will be one within the range of about 10 mM to about 2 M, about 10 mM to about 1.5 M, about 10 mM to about 1 M, about 10 mM to about 750 mM, about 10 mM to about 500 mM, about 10 mM to about 250 mM, about 20 mM to about 150 mM, about 20 mM, or about 150 mM. Other embodiments contemplate the use of different concentrations of phosphate ions in the binding and elution steps. In some embodiments, the concentration to phosphate ions ranges: between X mM and 1000 mM, where X is any integer between 1 and 999; between X mM and 750 mM, where X is any integer between 1 and 749; between X mM and 500 mM, where X is any integer between 1 and 499; between X mM and 250 mM, where X is any integer between 1 and 249; between X mM and 100 mM, where X is any integer between 1 and 99; between X mM and 50 mM, where X is any integer between 1 and 49. In certain embodiments, X is 1, 5, 10, 15, 20, 25, 30, 34, 40, 45, or 50. Optimal elution conditions for some proteins can involve a buffer with a higher salt concentration or a higher concentration of phosphate ions than that of the loading and/or wash buffer. In some instances, bound proteins can be eluted with a salt or phosphate gradient (see, for example, the examples provided herein). In other embodiments, a stepwise elution can be utilized in which the amount of salt or phosphate contained within a buffer is altered (e.g., increased) and passed over the column to elute bound protein.

The particulate TPHA substrate can be utilized in any conventional configuration, including packed columns and fluidized or expanded-bed columns, and by any conventional method, including batchwise modes for loading, washes, and elution, as well as continuous or flow-through modes. The use of a packed flow-through column is particularly convenient, both for preparative-scale extractions and analytical-scale extractions. A column may thus range in diameter from about 1 mm to about 1 m, and in height from about 1 cm to about 30 cm or more.

The chromatographic steps described herein can be performed in a conventional purification configuration including, but not limited to, packed columns and fluidized or expanded-bed columns and by any conventional chromatography method including batch modes for loading, washing, and elution, as well as continuous or flow-through modes. In some embodiments, the medium is packed in a column having a diameter ranging from less than 0.5 centimeter to more than a meter and a column height ranging from less than one centimeter to more than 30 centimeters. In other embodiments, the particulate TPHA substrate is provided in a spin column.

In other embodiments, the particulate TPHA substrate is provided in a chromatography column, the sample is applied to the top of the column and gravity forces the sample, wash buffers and/or elution buffers through the column. In other embodiments, a column containing the TPHA substrate can be run with or without pressure and from top to bottom or bottom to top, and the direction of the flow of fluid in the column can be reversed during the process. In some cases, it can be advantageous to reverse the flow of liquid while maintaining the packed configuration of the packed bed. The methods described herein can be used for purifying many types of target molecules, including viruses, naturally occurring proteins, antibodies, and recombinant proteins.

The output from the particulate TPHA substrate can be monitored for the presence of the target molecule or other components of the sample, as desired, to determine fractions that contain the target molecule and that are free, or at least have a reduced amount, of contaminant compared to the original sample. In some embodiments, at least 90%, 95%, 99% of the contaminant in the sample is removed in the resulting purified target molecule fractions. An exemplary method for measuring output includes monitoring a characteristic absorbance wavelength for the target molecule. The term “fraction” is used to refer to a portion of the output of chromatography and is not intended to limit how the output is collected or whether the output is collected in parts or continuously.

Any antibody preparation can be used in the present invention, including unpurified or partially purified antibodies from natural, synthetic, and/or recombinant sources. Unpurified antibody preparations can come from various sources such as, for example, plasma, serum, ascites, milk, plant extracts, bacterial lysates, yeast lysates, or conditioned cell culture media. Partially purified preparations can come from unpurified preparations that have been processed by at least one chromatography, precipitation, other fractionation step, or any combination thereof. In some embodiments, the antibodies have not been purified by protein A affinity prior to purification.

In certain embodiments, the particulate TPHA substrates can be used for purification of non-antibody proteins, including therapeutic proteins. Examples of therapeutic proteins include, but are not limited to, Factor VIII von Willebrand Factor enzymes, growth regulators, clotting factors, transcription factors and phosphoproteins.

All patents, patent applications, provisional applications, and publications referred to or cited herein are incorporated by reference in their entirety, including all figures and tables, to the extent they are not inconsistent with the explicit teachings of this specification.

### Producing Particulate TPHA Substrates

In general terms, a templated particulate hydroxyapatite (TPHA) chromatography substrate can be produced in the following generalized method. First, a desired particulate polymeric chromatography support substrate is chosen based on its chemical properties and morphological structure. This step is followed by growing a calcium phosphate (CaP) coating throughout the resin's pore network via alternating exposures to calcium ion containing solutions, washes, and phosphate containing solutions. Finally, the polymer support is pyrolyzed, CaP layer is converted to hydroxyapatite, and HA microstructure is formed, simultaneously, via high temperatures for specified amount of time. In some embodiments, the particulate polymeric substrate is treated at a temperature of at least 400° C. In some embodiments, the temperature ranges from about 400° C. to a temperature of about 2000° C. or the temperature ranges from at least 400° C. to a temperature of about 2000° C. In some embodiments the temperature ranges from about from about 1200° C. to a temperature of about 2000° C. or the temperature ranges from at least 1200° C. to a temperature of about 2000° C., where a minimum of 1200° C. is needed for full conversion of the TPHA to a ceramic form. In some embodiments, additional HA is deposited on the surface of TPHA particle using the disclosed procedures and the TPHA particle is subjected to pyrolysis again at a temperature of at least 400° C. In some embodiments, TPHA particles upon which additional HA is deposited are heated to temperature ranging from about 400° C. to a temperature of about 2000° C. or ranging from at least 400° C. to a temperature of about 2000° C. In some embodiments the temperature ranges from about from about 1200° C. to a temperature of about 2000° C. or the temperature ranges from at least 1200° C. to a temperature of about 2000° C., where a minimum of 1200° C. is needed for full conversion of the additional HA deposited upon the TPHA particles to a ceramic form.

The particulate substrate for the hydroxyapatite-polymer used to form a TPHA particle is a free-flowing, chromatography polymeric substrate with a polar surface, preferably an ionically charged surface. Particulate polymers of varying hydrophobicity and porosity can be used, including but not limited to methacrylate-based, styrene-based, agarose-based, and polyacrylamide-based particulate polymers. Porous particulate substrates with high surface area are preferred but the HA-coated substrate can be made from particulate substrates having smooth (non-porous) surfaces or dynamic gel-like networks. Polar functionality or preferably surface charge can be incorporated into the particulate polymeric substrate during the initial polymerization process by using an appropriate monomer. Alternatively, polarity or surface charge can be introduced after polymerization via chemical modifications, for example coupling ligands to epoxide groups on the substrate. Types of surface charges include but are not limited to strong cation exchange ligands like sulphonates, strong anion exchange ligands like quaternary amines, and weak cation exchange groups like carboxylic acids, sulphates, and phosphates.

Particulate substrates of various shapes, diameters and/or dimensions can also be used, including small-sized particles (<50 μm in at least one dimension e.g., length, width, diameter, and/or height), medium-sized particles (about 50 to about 100 μm in at least one dimension e.g., length, width, diameter, and/or height), and large-sized particles (greater than about 100 μm in at least one dimension e.g., length, width, diameter, and/or height).

The method used to grow the CaP layer involves cyclic exposures of the particulate substrate to solutions of calcium ions, washes, phosphate ions, and further washes. Various types of calcium ion-containing and phosphate ion-containing solutions can be prepared. The calcium source is a solubilized salt of calcium and is selected to reduce the amount of undesired impurities. The preferred calcium source is calcium chloride. Calcium solutions of varying concentrations can be used, ranging but not limited to 50-1000 mM. Some embodiments utilize calcium concentrations between about 250 mM and about 500 mM. Solutions can be made of varying concentrations, ranging from but not limited to 10 mM to about 1000 mM, about 20 mM to about 750 mM, about 30 mM to about 500 mM, about 30 mM to about 400 mM, or a concentration of about 300 mM. Alternatively, the calcium solutions have a concentration between about 10 mM and about A mM, wherein A is any integer between 11 and 1000. Buffers that do not form insoluble precipitates with calcium can be incorporated, but a preferred solution contains only the chosen calcium salt.

The phosphate source can be any solubilized salt of phosphate and is selected to reduce the amount of undesired ions and other small molecules. A preferred phosphate source is dibasic sodium phosphate heptahydrate. The anhydrous form, as well as the potassium and ammonium salts, are also compatible. Phosphate solutions can be made of varying concentrations, ranging from but not limited to 10 mM to about 1000 mM, about 20 mM to about 750 mM, about 30 mM to about 500 mM, about 30 mM to about 400 mM, or a concentration of about 300 mM and may be, optionally, heated to a temperature of about 40° C. to about 100° C., about 45° C. to about 90° C., about 50° C. to about 80° C., or about 70° C. Alternatively, the phosphate solutions have a concentration between about 10 mM and about B mM, wherein B is any integer between 11 and 1000 and may be, optionally, heated to a temperature of about 40° C. to about 100° C., about 45° C. to about 90° C., about 50° C. to about 80° C., or about 70° C. Buffers that do not form insoluble precipitates with phosphates can be incorporated, but the preferred solution contains only the chosen phosphate salt.

For the deposition process, particulate substrates are exposed to the following cycles. For cation exchange substrates, CaP coatings were grown by repeatedly exposing the substrates to: (a) calcium solution, (b) water washes, (c) phosphate solution, and (d) water washes. For anion exchange substrates, CaP coatings were grown by repeatedly exposing the substrates to the following cycle of solutions: (a) phosphate solution, (b) water washes, (c) calcium solution, and (d) water washes. Switching these methods can be done but typically the first half does not contribute significantly to CaP growth. For polar, non-ionically charged particulate surfaces, either process can be used.

Different configurations can be used to expose the base particulate polymeric substrates to the various aqueous environments if the particulate substrate can be washed well between the calcium and phosphate solution exposures. Two configurations are the column format and the reactor format. In the column format, the particulate substrate is packed into a chromatographic column and the appropriate solutions are passed through the columns. Different parameters can be varied including the concentrations of calcium and phosphate solutions, flowrate, number of cycles, and type of base substrate used.

For the reactor format, the particulate substrate is placed in a reactor, preferably containing a fritted drain. For each step, either the calcium solution, phosphate solution, or water wash is added to the reactor. After agitating the slurry by mechanical stirring, swirling, or bubbling, the solution or water wash is removed from the particulate substrate. Various parameters can be changed to affect the amount of growth, morphology, and impurities/unwanted CaP debris. Parameters include, frit size and morphology, contact time with each solution, volume and concentrations of salt solutions, washing method (e.g. number, volume, duration), number of overall cycles, and method to agitate the substrate within the solution.

Conversion of the CaP to hydroxyapatite, formation of the HA microstructure, and pyrolysis of the polymer template are done concurrently at high temperatures. Time, temperature, and heating rate can be adjusted to alter the degree of conversion of the CaP layer into hydroxyapatite and the graining of the crystals. The temperature must be sufficient to decompose the polymer layer underneath, leaving negative space and becoming the pore network for this material.

The temperature used to sinter the HA-coated substrates can be based upon the polymer used to form the particulate substrate. In some embodiments, sintering can be performed at a temperature of at least 400° C. for a period of about 6 to about 24 hours. In other embodiments, sintering is performed at a temperature of about 600° C. for a period of about 6 to about 24 hours. Yet other embodiments provide for sintering at a temperature of about E° C., where E is any integer between 400 and 1000, preferably at least 600. In other embodiments, sintering can be performed at a temperature of: a) at least 400° C.; b) about E° C., where E is any integer between 400 and 2000, preferably at least 600; c) about E° C., where E is any integer between about 1200 and about 2000, preferably at least 1200; or d) at least E° C., where E is any integer between 1200 and 2000. Sintering can be performed for periods of at least 6 to 24 hours or about 6 to 24 hours.

As discussed above, after a first pyrolysis step is conducted, additional HA can be formed on the surface of the pyrolyzed substrate and the TPHA particles can be subjected to additional pyrolysis steps. In some embodiments, the first pyrolysis step is performed at a temperature that is lower than the second pyrolysis step. In other embodiments, the first pyrolysis step is performed a temperature that is higher than the second pyrolysis step. These steps can be repeated as desired.

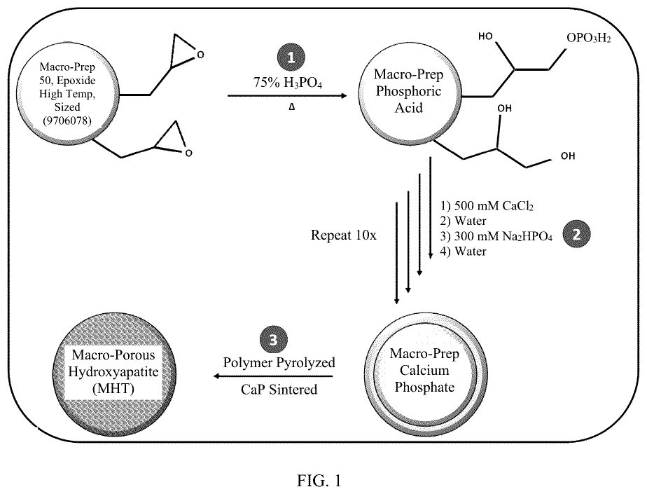

TPHA substrates can be produced by contacting a solid particulate substrate (porous or non-porous) comprising a functional group with a series of solutions. The functional group associated with the substrate can be a hydroxyl group, amine group, quarternary amine group, aldehyde group, azide group, alkyne group, alkene group, phosphate group, sulfonate group, sulfate group, and/or carboxylic acid (see, for example, FIG. 1). Methods of producing TPHA substrates comprise:
a) contacting a solid particulate substrate comprising a hydroxyl group, amine group, quaternary amine group, aldehyde group, azide group, alkyne group, alkene group, phosphate group, sulfonate group, sulfate group, and/or carboxylic acid group with a solution comprising calcium ions, with the proviso that if a substrate comprises positively charged groups it may be contacted with a phosphate containing solution and washed prior to contact with a solution comprising calcium ions (for example, CaCl₂));
b) washing the solid substrate contacted with the solution comprising calcium ions with a solution (for example, water);
c) contacting the washed solid substrate of step b) with a solution comprising phosphate ions, such as the sodium salt of phosphoric acid (Na₂HPO₄) to form a solid substrate coated with a brushite form of calcium phosphate;
d) washing the solid substrate of step c) with a solution (for example, water); and
e) optionally repeating steps b), c), and d). When step e) is repeated, it can be repeated any number of times until a suitably HA-coated substrate is obtained. For example, step e) can be repeated Y times, where Y is any integer between 1 and 5000. In some embodiments, Y is an integer between 1 and 100, 1 and 50, 1 and 20, or 1 and 10. The CaP-coated substrates are then pyrolyzed at a temperature of at least 400° C. for a period of time suitable to substantially remove the substrate, to convert CaP to HA, and to achieve a desirable HA microstructure so as to form a macroporous TPHA particle. Steps a) through e) can be repeated to form additional HA on the surface of the TPHA particle and the TPHA particles upon which additional HA has been deposited can be subjected to another step of pyrolysis at temperature of at least 400° C. In some embodiments, the solid substrate can be treated with a strong base at elevated temperatures for a specified amount of time prior to pyrolysis in order to convert the brushite to HA. Exemplary strong bases include, and are not limited to, LiOH, NaOH, KOH, RbOH, CsOH, Ca(OH)₂, Sr(OH)₂, and Ba(OH)₂.

In other embodiments, when the HA-coated substrate starts with a substrate that comprises positively charged groups, the method comprises: a) contacting the solid porous substrate with a solution comprising phosphate ions; b) washing the solid porous substrate contacted with the solution comprising phosphate ions; c) contacting the solid porous substrate of step b) with a solution comprising calcium ions; d) washing the solid substrate contacted with the solution comprising calcium ions with a wash solution; e) contacting the washed solid substrate of step b) with a solution comprising phosphate ions to form a solid substrate coated with a brushite form of calcium phosphate; f) washing the solid substrate of step c) with a solution to form a brushite-coated substrate; g) optionally repeating steps c), d), e), and f); and h) treating the brushite coated substrate with a strong base to form a HA-coated substrate.

In instances where the solid substrate comprises an epoxide group, the epoxide-bearing substrate can be contacted with strong acids such as phosphoric acid, or solutions with reactive molecules containing 2 or more functional groups with at least one being a carboxylic acid to form a substrate bearing phosphate, carboxylate, or sulfate groups. In such methods, the epoxide-bearing substrate is contacted with phosphoric acid carboxylic acid, or sulfuric acid at a temperature of about 55° C. to about 100° C., about 60° C. to about 90° C., about 65° C. to about 80° C., or about 70° C. in order to form a substrate comprising bearing phosphate, carboxylate, or sulfate groups. These substrates can then be used in step a) of the method described above to form a HA-coated substrate.

### ADDITIONAL DISCLOSURE AND CLAIMABLE SUBJECT MATTER

1. A templated porous hydroxyapatite (TPHA) particle made by a method comprising:
a) contacting a solid porous or non-porous particulate substrate comprising a hydroxyl group, amine group, quaternary amine group, aldehyde group, azide group, alkyne group, alkene group, phosphate group, sulfonate group, sulfate group, and/or carboxylic acid group with a solution comprising calcium ions, with the proviso that if a substrate comprises positively charged groups it may be contacted with a phosphate containing solution and washed prior to contact with a solution comprising calcium ions;
b) washing the solid substrate contacted with the solution comprising calcium ions with a wash solution;
c) contacting the washed solid substrate of step b) with a solution comprising phosphate ions to form a solid substrate coated with a brushite form of calcium phosphate;
d) washing the solid substrate of step c) with a solution to form a brushite-coated substrate; and
e) optionally repeating steps b), c), and d); and
f) pyrolyzing the CaP-coated substrate to form a templated porous HA (TPHA) particle in which the particulate substrate has been substantially removed, the CaP converted to HA, and the HA microstructure manipulated by heating.
2. The TPHA particle of embodiment 1, wherein when step e) is repeated, it is repeated Y times, where Y is any integer between 1 and 5000, Y is an integer between 1 and 100, Y is an integer between 1 and 50, Y is an integer between 1 and 20, or Y is an integer between 1 and 10.
3. The TPHA particle of any one of embodiments 1-2, wherein the particulate substrate comprises methacrylate, polystyrene, agarose, dextran, cellulose, polyacrylamide, or mixtures thereof.
4. The TPHA particle of any one of embodiments 1-3, wherein the particulate substrate is porous.
5. The TPHA particle of any one of embodiments 1-3, wherein the particulate substrate is non-porous.
6. The TPHA particle of any one of embodiments 1-5, wherein the particulate substrate is washed with water in steps b) and/or d).
7. The TPHA particle of any one of embodiments 1-6, wherein the particulate substrate comprises a sulfate group.
8. The TPHA particle of any one of embodiments 1-6, wherein the particulate substrate comprises a carboxylate group.
9. The TPHA particle of any one of embodiments 1-6, wherein the particulate substrate comprises a phosphate group.
10. The TPHA particle of any one of embodiments 1-9, wherein the solution comprising phosphate ions is a sodium salt of phosphoric acid (Na₂HPO₄).
11. The TPHA particle of any one of embodiments 1-10, wherein the solution comprising calcium ions is CaCl₂).
12. The TPHA particle of any preceding embodiment, wherein the calcium solution has a concentration between: about 50 to about 1000 mM; about 250 mM and about 500 mM; about 10 mM to about 1000 mM; about 20 mM to about 750 mM; about 30 mM to about 500 mM; about 30 mM to about 400 mM; about 10 mM and about A mM, wherein A is any integer between 11 and 1000; or about 300 mM.
13. The TPHA particle of any preceding embodiment, wherein the phosphate solution has a concentration between: about 10 mM to about 1000 mM; about 20 mM to about 750 mM; about 30 mM to about 500 mM; about 30 mM to about 400 mM; about 10 mM and about B mM, wherein B is any integer between 11 and 1000.
14. The TPHA particle of any preceding embodiment, wherein the particulate substrate comprises cubes, cuboids, prisms, pyramids, platonic solids, torus, cone, cylinder, spheres and mixtures thereof having at least one dimension that is between about 1 μm and about 1000 μm; between about 5 μm and about 750 μm; between about 5 μm and about 600 μm; between about 5 μm and about 500 μm; between about 5 μm and about 400 μm; between about 5 μm and about 250 μm; between about 5 μm and about 150 μm; or between about 5 μm and about 100 μm as a length, width, diameter, and/or height, the particulate substrate being monodisperse or polydisperse.
15. The TPHA particle of embodiment 14, wherein the particulate substrate is a sphere having a diameter of: between about 1 μm and about 1000 μm; less than about 50 μm, between about 50 μm and about 100 μm; or greater than 100 μm and less than about 1000 μm.
16. The TPHA particle of embodiments 1-15, wherein steps a) through e) are repeated.
17. The TPHA particle of embodiment 16, wherein said pyrolysis step is repeated.
18. The TPHA particle of embodiments 1-17, wherein said pyrolysis step comprises heating the HA-coated particles at a temperature of: a) at least 400° C.; b) about E° C., where E is any integer between 400 and 2000, preferably at least 600; c) about E° C., where E is any integer between about 1200 and about 2000, preferably at least 1200; or d) at least E° C., where E is any integer between 1200 and 2000.
19. The TPHA particle of any one of embodiments 1-18, wherein:
a) the first pyrolysis step is performed at a temperature of about 400° C. and the second pyrolysis or subsequent step(s) is(are) performed at a temperature of about 600° C.;
b) the first pyrolysis step is performed at a temperature of about 600° C. and the second or subsequent pyrolysis step(s) is(are) performed at a temperature of about 400° C.;
c) the first pyrolysis step is performed at a temperature of about E° C. and the second or subsequent pyrolysis step(s) is(are) performed at a temperature of about E° C., where E is any integer between 400 and 2000 and the second pyrolysis or subsequent pyrolysis step(s) is(are) performed at a temperature that is at least about 50° C. higher than the first pyrolysis step; or
d) the first pyrolysis step is performed at a temperature of about E° C. and the second pyrolysis step is performed at a temperature of about E° C., where E is any integer between 400 and 2000 and the second pyrolysis step is performed at a temperature that is at least about 50° C. lower than the first pyrolysis step;
e) the first pyrolysis step is performed at a temperature of about E° C. and the second pyrolysis step is performed at a temperature of about E° C., where E is any integer between 1200 and 2000 and the second pyrolysis step is performed at a temperature that is at least about 50° C. lower than the first pyrolysis step, with the proviso that the first pyrolysis step is performed at a temperature of at least 1250° C.; or
f) the first pyrolysis step is performed at a temperature of about E° C. and the second pyrolysis step is performed at a temperature of about E° C., where E is any integer between 1200 and 2000 and the second pyrolysis step is performed at a temperature that is at least about 50° C. higher than the first pyrolysis step, with the proviso that the first pyrolysis step is performed at a temperature of at least 1250° C.
20. The TPHA particle of any one of embodiments 1-19, wherein brushite is converted to HA by treating the brushite-coated substrate with NaOH.
21. The TPHA particle of embodiment 20, wherein the brushite-coated substrate is treated with NaOH and heated to a temperature of about 55° C. to about 100° C., about 60° C. to about 90° C., about 65° C. to about 80° C., or about 70° C.
22. The TPHA particle of embodiment 21, wherein the brushite-coated substrate is treated with NaOH and heated to a temperature of temperature of about 70° C.
23. A method of making a templated porous hydroxyapatite (TPHA)-coated particle comprising:
a) contacting a solid porous or non-porous particulate substrate comprising a hydroxyl group, amine group, quarternary amine group, aldehyde group, azide group, alkyne group, alkene group, phosphate group, sulfonate group, sulfate group, and/or carboxylic acid, with the proviso that if a substrate comprises positively charged groups it may be contacted with a phosphate containing solution and washed prior to contact with a solution comprising calcium ions;
b) washing the solid substrate contacted with the solution comprising calcium ions with a wash solution;
c) contacting the washed solid substrate of step b) with a solution comprising phosphate ions to form a solid substrate coated with a brushite form of calcium phosphate;
d) washing the solid substrate of step c) with a solution to form a brushite-coated substrate; and
e) optionally repeating steps b), c), and d); and
f) pyrolyzing the HA-coated substrate to form a templated porous HA (TPHA) particle in which the particulate substrate has been substantially removed by heating.
24. The method of embodiment 23, wherein when step e) is repeated, it is repeated Y times, where Y is any integer between 1 and 5000, Y is an integer between 1 and 100, Y is an integer between 1 and 50, Y is an integer between 1 and 20, or Y is an integer between 1 and 10.
25. The method of any one of embodiments 23-24, wherein the particulate substrate comprises methacrylate, polystyrene, agarose, dextran, cellulose, polyacrylamide, or mixtures thereof.
26. The method of any one of embodiments 23-25, wherein the particulate substrate is porous.
27. The method of any one of embodiments 23-25, wherein the particulate substrate is non-porous.
28. The method of any one of embodiments 23-27, wherein the particulate substrate is washed with water in steps b) and/or d).
29. The method of any one of embodiments 23-28, wherein the particulate substrate comprises a sulfate group.
30. The method of any one of embodiments 23-28, wherein the particulate substrate comprises a carboxylate group.
31. The method of any one of embodiments 23-28, wherein the particulate substrate comprises a phosphate group.
32. The method of any one of embodiments 23-31, wherein the solution comprising phosphate ions is a sodium salt of phosphoric acid (Na₂HPO₄).
33. The method of any one of embodiments 23-32, wherein the solution comprising calcium ions is CaCl₂).
34. The method of any preceding embodiment, wherein the calcium solution has a concentration between: about 50 to about 1000 mM; about 250 mM and about 500 mM; about 10 mM to about 1000 mM; about 20 mM to about 750 mM; about 30 mM to about 500 mM; about 30 mM to about 400 mM; about 10 mM and about A mM, wherein A is any integer between 11 and 1000; or about 300 mM.
35. The method of any preceding embodiment, wherein the phosphate solution has a concentration between: about 10 mM to about 1000 mM; about 20 mM to about 750 mM; about 30 mM to about 500 mM; about 30 mM to about 400 mM; about 10 mM and about B mM, wherein B is any integer between 11 and 1000.
36. The method of any preceding embodiment, wherein the particulate substrate comprises cubes, cuboids, prisms, pyramids, platonic solids, torus, cone, cylinder, spheres and mixtures thereof having at least one dimension that is between about 1 μm and about 1000 μm; between about 5 μm and about 750 μm; between about 5 μm and about 600 μm; between about 5 μm and about 500 μm; between about 5 μm and about 400 μm; between about 5 μm and about 250 μm; between about 5 μm and about 150 μm; or between about 5 μm and about 100 μm as a length, width, diameter, and/or height.
37. The method of embodiment 36, wherein the particulate substrate is a sphere having a diameter of: between about 1 μm and about 1000 μm; less than about 50 μm, between about 50 μm and about 100 μm; or greater than 100 μm and less than about 1000 μm.
38. The method of any one of embodiments 23-37, wherein the method further comprises repeating steps a) through e).
39. The method of embodiment 38, said method further comprising performing a further pyrolysis step.
40. The method of embodiments 23-39, wherein said pyrolysis step comprises heating the HA-coated particles at a temperature of: a) at least 400° C.; b) about E° C., where E is any integer between 400 and 2000, preferably at least 600; c) about E° C., where E is any integer between about 1200 and about 2000, preferably at least 1200; or d) at least E° C., where E is any integer between 1200 and 2000.
41. The method of any one of embodiments 23-40, wherein:
a) the first pyrolysis step is performed at a temperature of about 400° C. and the second pyrolysis or subsequent step(s) is(are) performed at a temperature of about 600° C.;
b) the first pyrolysis step is performed at a temperature of about 600° C. and the second or subsequent pyrolysis step(s) is(are) performed at a temperature of about 400° C.;
c) the first pyrolysis step is performed at a temperature of about E° C. and the second or subsequent pyrolysis step(s) is(are) performed at a temperature of about E° C., where E is any integer between 400 and 2000 and the second pyrolysis or subsequent pyrolysis step(s) is(are) performed at a temperature that is at least about 50° C. higher than the first pyrolysis step; or
d) the first pyrolysis step is performed at a temperature of about E° C. and the second pyrolysis step is performed at a temperature of about E° C., where E is any integer between 400 and 2000 and the second pyrolysis step is performed at a temperature that is at least about 50° C. lower than the first pyrolysis step;
e) the first pyrolysis step is performed at a temperature of about E° C. and the second pyrolysis step is performed at a temperature of about E° C., where E is any integer between 1200 and 2000 and the second pyrolysis step is performed at a temperature that is at least about 50° C. lower than the first pyrolysis step, with the proviso that the first pyrolysis step is performed at a temperature of at least 1250° C.; or
f) the first pyrolysis step is performed at a temperature of about E° C. and the second pyrolysis step is performed at a temperature of about E° C., where E is any integer between 1200 and 2000 and the second pyrolysis step is performed at a temperature that is at least about 50° C. higher than the first pyrolysis step, with the proviso that the first pyrolysis step is performed at a temperature of at least 1250° C.
42. The method of any one of embodiments 23-41, wherein brushite is converted to HA by treating the brushite-coated substrate with a strong base, such as NaOH, prior to pyrolysis.
43. The method of embodiment 42, wherein the brushite-coated substrate is treated with NaOH and heated to a temperature of about 55° C. to about 100° C., about 60° C. to about 90° C., about 65° C. to about 80° C., or about 70° C.
44. The method of embodiment 43, wherein the brushite-coated substrate is treated with NaOH and heated to a temperature of temperature of about 70° C.
45. The TPHA particle of any one of embodiments 1-22, wherein brushite is converted to HA by treating the brushite-coated substrate with a strong base, such as NaOH, prior to pyrolysis.
46. The TPHA particle of embodiment 45, wherein the brushite-coated substrate is treated with NaOH and heated to a temperature of about 55° C. to about 100° C., about 60° C. to about 90° C., about 65° C. to about 80° C., or about 70° C.
47. The TPHA particle of embodiment 46, wherein the brushite-coated substrate is treated with NaOH and heated to a temperature of temperature of about 70° C.
48. A chromatography column comprising a plurality of TPHA particles of any one of embodiments 1-22 or 45-47.
49. A method of performing chromatography, the method comprising:
   contacting a sample comprising a target molecule to a plurality of TPHA particles according to any one of embodiments 1-22 or 45-47 under conditions such that the target is not captured by the plurality of TPHA particle; and
   collecting the target molecule from eluate that has flowed through the plurality of TPHA particles.
50. The method of embodiment 49, wherein the sample comprises a contaminant that is captured by the TPHA particle.
51. The method of embodiment 49, wherein the collecting step comprises applying centrifugal force or a vacuum to the plurality of TPHA particle and collecting one or more fractions enriched for the target molecule.
52. The method of embodiment 49, wherein the target molecule is an IgG antibody.
53. A method of performing chromatography, the method comprising:
contacting a sample comprising a target molecule to a plurality of TPHA particles according to any one of embodiments 1-22 or 45-47 under conditions such that the target molecule is captured by the plurality of TPHA particle;
optionally washing the plurality of TPHA particles with a buffer; and
eluting and collecting the target molecule.
54. The method of embodiment 53, wherein the target molecule is an IgG antibody.

### Example 1

### Macro-Prep P-Templated HA Resin

A Macro-Prep precursor resin containing epoxides was reacted with concentrated phosphoric acid at 70° C. for 3 hours to create a phosphate functionalized Macro-Prep based cation exchange resin. The resulting resin, MPP, was tested for conversion by ATR-FTIR and the modification was quantitated by pH titration.

25 mL of resin was added to a reaction vessel containing frits at the bottom that could be drained by applying vacuum. For CaP growth cycling, solution was mixed with the resin and drained before proceeding to the next step or follow-up washes. Various mixing methods were tested from swirling the container and over-head mixing. Solutions were added as follows: (a) 50 mL 500 mM CaCl₂), (b) 3 washes of 50 mL deionized water, (c) 50 mL 300 mM Na2PO4, and (d) 3 washes of 50 mL deionized water. 10 cycles were carried out. Resin was subsequently dried using a final methanol wash and a placed in a vacuum chamber overnight. Some iterations used different frits, reactors, and number of washes.

Afterwards, the resin was imaged by scanning electron microscopy, and 10,000×images show the resin is covered in rough surface of calcium phosphate. Distinct needles were not observed, and 50,000× magnification shows a smoother surface speckled with holes. Depending on the quality of washing, some batches had larger plate-like CaP structures embedded in the surface or formed separately from the resin surface. Resin was analyzed by FT-IR (Fourier transform infrared spectroscopy) showing a hydroxyapatite like signature with broad peaks.

CaP-coated resins were sintered at three different temperatures. The resin was placed in a sintering oven exposed to atmospheric air. The ovens were preheated to 200, 400, and 600° C. and the resins were placed in the oven for 24 h. Resin was cooled using ambient air and imaged by scanning electron microscopy, showing a resin with a porous network and hydroxyapatite structuring. The phase and presence of the polymer scaffold was confirmed by ATR-FTIR. Different temperatures were used to obtain different degrees of degradation of the Macro-Prep base polymer and different hydroxyapatite microstructures.

### Example 2

### UNOsphere S-Templated HA Resin

25 mL of resin was added to a reaction vessel containing frits at the bottom that could be drained by applying vacuum. For CaP growth cycling, solution was mixed with the resin and drained before proceeding to the next step or follow-up washes. Various mixing methods were tested from swirling the container and over-head mixing. Solutions were added as follows: (a) 50 mL 500 mM CaCl2), (b) 3 washes of 50 mL deionized water, (c) 50 mL 300 mM Na2PO4, and (d) 3 washes of 50 mL deionized water. 10 cycles were carried out. Resin was subsequently dried using a final methanol wash and a placed in a vacuum chamber overnight. Some iterations used different frits, reactors, and number of washes.

Afterwards, the resin was imaged by scanning electron microscopy, and 10,000×images show the resin is covered in rough surface of calcium phosphate. Distinct needles were not observed, and 50,000× magnification shows a smoother surface speckled with holes. Depending on the quality of washing, some batches had larger plate-like CaP structures embedded in the surface or formed separately from the resin surface. Resin was analyzed by FT-IR (Fourier transform infrared spectroscopy) showing a hydroxyapatite like signature with broad peaks.

CaP-coated resins were sintered at a temperature that decomposes UNOsphere S. The resin was placed in a sintering oven exposed to atmospheric air. The oven was preheated to 400° C. and the resin was placed in the oven for 24 h. Resin was cooled using ambient air and imaged by scanning electron microscopy, showing a resin with a porous network and hydroxyapatite structuring. The phase and presence of the polymer scaffold was confirmed by ATR-FTIR.

### Example 3

### Nuvia S-Templated HA Resin

25 mL of resin was added to a reaction vessel containing frits at the bottom that could be drained by applying vacuum. For CaP growth cycling, solution was mixed with the resin and drained before proceeding to the next step or follow-up washes. Various mixing methods were tested from swirling the container and over-head mixing. Solutions were added as follows: (a) 50 mL 500 mM CaCl2), (b) 3 washes of 50 mL deionized water, (c) 50 mL 300 mM Na2PO4, and (d) 3 washes of 50 mL deionized water. 10 cycles were carried out. Resin was subsequently dried using a final methanol wash and a placed in a vacuum chamber overnight. Some iterations used different frits, reactors, and number of washes.

Afterwards, the resin was imaged by scanning electron microscopy, and 10,000×images show the resin is covered in rough surface of calcium phosphate. Distinct needles were not observed, and 50,000× magnification shows a smoother surface speckled with holes. Depending on the quality of washing, some batches had larger plate-like CaP structures embedded in the surface or formed separately from the resin surface. Resin was analyzed by FT-IR (Fourier transform infrared spectroscopy) showing a hydroxyapatite like signature with broad peaks.

CaP-coated resins were sintered at a temperature that decomposes Nuvia S. The resin was placed in a sintering oven exposed to atmospheric air. The oven was preheated to 400° C. and the resin was placed in the oven for 24 h. Resin was cooled using ambient air and imaged by scanning electron microscopy, showing a hollow resin shell with a porous network and hydroxyapatite structuring. The phase and presence of the polymer scaffold was confirmed by ATR-FTIR.

### Example 4

### Polymer-Templated HA Resin Binding Capacity

This example demonstrates the chromatographic performance of polymer-templated HA resins (material from example 1 & 2). 1.0 mL of Macro-Prep HA is packed in a 1 mL chromatography column. The conditions were as followed:
Column: 0.56×4.00 cm
Flow Rate: 150 cm/h
Sample: 5 mg/mL Bovine T-Globulin in 10 mM Sodium Phosphate, pH 7.0 Dynamic binding capacity is obtained by the 10% breakthrough.

We claim:

1. A templated porous hydroxyapatite (TPHA) particle made by a method comprising:
a) contacting a solid porous or non-porous particulate substrate comprising a hydroxyl group, amine group, quaternary amine group, aldehyde group, azide group, alkyne group, alkene group, phosphate group, sulfonate group, sulfate group, and/or carboxylic acid group with a solution comprising calcium ions, with the proviso that if a substrate comprises positively charged groups it may be contacted with a phosphate containing solution and washed prior to contact with a solution comprising calcium ions;
b) washing the solid substrate contacted with the solution comprising calcium ions with a wash solution;
c) contacting the washed solid substrate of step b) with a solution comprising phosphate ions to form a solid substrate coated with a brushite form of calcium phosphate;
d) washing the solid substrate of step c) with a solution to form a brushite-coated substrate; and
e) optionally repeating steps b), c), and d); and
f) pyrolyzing the CaP-coated substrate to form a templated porous HA (TPHA) particle in which the particulate substrate has been substantially removed, the CaP converted to HA, and the HA microstructure manipulated by heating.

2. The TPHA particle of claim 1, wherein when step e) is repeated, it is repeated Y times, where Y is any integer between 1 and 5000, Y is an integer between 1 and 100, Y is an integer between 1 and 50, Y is an integer between 1 and 20, or Y is an integer between 1 and 10.

3. The TPHA particle of claim 1, wherein the particulate substrate comprises methacrylate, polystyrene, agarose, dextran, cellulose, polyacrylamide, or mixtures thereof.

4. The TPHA particle of claim 1, wherein the particulate substrate is porous or non-porous.

5. The TPHA particle of claim 1, wherein the particulate substrate comprises a sulfate group, a carboxylate group, or a phosphate group.

6. The TPHA particle of claim 1, wherein the solution comprising phosphate ions is a sodium salt of phosphoric acid (Na₂HPO₄).

7. The TPHA particle of claim 1, wherein the solution comprising calcium ions is CaCl₂).

8. The TPHA particle of claim 1, wherein the calcium solution has a concentration between: about 50 to about 1000 mM; about 250 mM and about 500 mM; about 10 mM to about 1000 mM; about 20 mM to about 750 mM; about 30 mM to about 500 mM; about 30 mM to about 400 mM; about 10 mM and about A mM, wherein A is any integer between 11 and 1000; or about 300 mM.

9. The TPHA particle of claim 1, wherein the phosphate solution has a concentration between: about 10 mM to about 1000 mM; about 20 mM to about 750 mM; about 30 mM to about 500 mM; about 30 mM to about 400 mM; about 10 mM and about B mM, wherein B is any integer between 11 and 1000.

10. The TPHA particle of claim 1, wherein steps a) through e) are repeated.

11. The TPHA particle of claim 1, wherein said pyrolysis step is repeated.

12. The TPHA particle of claim 1, wherein said pyrolysis step comprises heating the HA-coated particles at a temperature of: a) at least 400° C.; b) about E° C., where E is any integer between 400 and 2000; c) about E° C., where E is any integer between about 1200 and about 2000; or d) at least E° C., where E is any integer between 1200 and 2000.

13. The TPHA particle of claim 1, wherein:
a) the first pyrolysis step is performed at a temperature of about 400° C. and the second pyrolysis or subsequent step(s) is(are) performed at a temperature of about 600° C.;
b) the first pyrolysis step is performed at a temperature of about 600° C. and the second or subsequent pyrolysis step(s) is(are) performed at a temperature of about 400° C.;
c) the first pyrolysis step is performed at a temperature of about E° C. and the second or subsequent pyrolysis step(s) is(are) performed at a temperature of about E° C., where E is any integer between 400 and 2000 and the second pyrolysis or subsequent pyrolysis step(s) is(are) performed at a temperature that is at least about 50° C. higher than the first pyrolysis step; or
d) the first pyrolysis step is performed at a temperature of about E° C. and the second pyrolysis step is performed at a temperature of about E° C., where E is any integer between 400 and 2000 and the second pyrolysis step is performed at a temperature that is at least about 50° C. lower than the first pyrolysis step;
e) the first pyrolysis step is performed at a temperature of about E° C. and the second pyrolysis step is performed at a temperature of about E° C., where E is any integer between 1200 and 2000 and the second pyrolysis step is performed at a temperature that is at least about 50° C. lower than the first pyrolysis step, with the proviso that the first pyrolysis step is performed at a temperature of at least 1250° C.; or
f) the first pyrolysis step is performed at a temperature of about E° C. and the second pyrolysis step is performed at a temperature of about E° C., where E is any integer between 1200 and 2000 and the second pyrolysis step is performed at a temperature that is at least about 50° C. higher than the first pyrolysis step, with the proviso that the first pyrolysis step is performed at a temperature of at least 1250° C.

14. The TPHA particle of claim 1, wherein brushite is converted to HA by treating the brushite-coated substrate with NaOH.

15. The TPHA particle of claim 14, wherein the brushite-coated substrate is treated with NaOH and heated to a temperature of about 55° C. to about 100° C., about 60° C. to about 90° C., about 65° C. to about 80° C., or about 70° C.

16. The TPHA particle of claim 1, wherein brushite is converted to HA by treating the brushite-coated substrate with a strong base prior to pyrolysis.

17. The TPHA particle of claim 16, wherein the brushite-coated substrate is treated with NaOH and heated to a temperature of about 55° C. to about 100° C., about 60° C. to about 90° C., about 65° C. to about 80° C., or about 70° C.

18. The TPHA particle of claim 17, wherein the brushite-coated substrate is treated with NaOH and heated to a temperature of temperature of about 70° C.

19. A method of making a templated porous hydroxyapatite (TPHA)-coated particle comprising:
a) contacting a solid porous or non-porous particulate substrate comprising a hydroxyl group, amine group, quarternary amine group, aldehyde group, azide group, alkyne group, alkene group, phosphate group, sulfonate group, sulfate group, and/or carboxylic acid, with the proviso that if a substrate comprises positively charged groups it may be contacted with a phosphate containing solution and washed prior to contact with a solution comprising calcium ions;
b) washing the solid substrate contacted with the solution comprising calcium ions with a wash solution;
c) contacting the washed solid substrate of step b) with a solution comprising phosphate ions to form a solid substrate coated with a brushite form of calcium phosphate;
d) washing the solid substrate of step c) with a solution to form a brushite-coated substrate; and
e) optionally repeating steps b), c), and d); and
f) pyrolyzing the HA-coated substrate to form a templated porous HA (TPHA) particle in which the particulate substrate has been substantially removed by heating.

20. A chromatography column comprising a plurality of TPHA particles according to claim 1.

21. A chromatography column comprising a plurality of TPHA particles according to claim 16.

22. A method of performing chromatography, the method comprising:
contacting a sample comprising a target molecule to a plurality of TPHA particles according to claim 1 under conditions such that the target is not captured by the plurality of TPHA particle; and
collecting the target molecule from eluate that has flowed through the plurality of TPHA particles.

23. A method of performing chromatography, the method comprising:
contacting a sample comprising a target molecule to a plurality of TPHA particles according to claim 16 under conditions such that the target is not captured by the plurality of TPHA particle; and
collecting the target molecule from eluate that has flowed through the plurality of TPHA particles.

24. A method of performing chromatography, the method comprising:
contacting a sample comprising a target molecule to a plurality of TPHA particles according to claim 1 under conditions such that the target molecule is captured by the plurality of TPHA particle;
optionally washing the plurality of TPHA particles with a buffer; and
eluting and collecting the target molecule.

25. A method of performing chromatography, the method comprising:
contacting a sample comprising a target molecule to a plurality of TPHA particles according to claim 16 under conditions such that the target molecule is captured by the plurality of TPHA particle;
optionally washing the plurality of TPHA particles with a buffer; and
eluting and collecting the target molecule.
